(19) United States
(12) Patent Application Publication
(10) Pub. No.: US 2026/0010414 A1
(43) Pub. Date: Jan. 8, 2026

(54) AUTONOMOUS DEPLOYMENT BASED ON CARBON FOOTPRINT FOR APPLICATIONS

(71) Applicant: Oracle International Corporation, Redwood Shores, CA (US)

(72) Inventors: Anderson Pimentel da Silva Topine, Valbonne (FR); Nicolas Ponsini, Mougins (FR)

(73) Assignee: Oracle International Corporation, Redwood Shores, CA (US)

(21) Appl. No.: 18/763,159

(22) Filed: Jul. 3, 2024

(51) Int. Cl. G06F 9/50; G06Q 30/018

(52) U.S. Cl. CPC G06F 9/5083; G06Q 30/018

(57) ABSTRACT

A workload management system monitors a tenant-specific workload for a tenant on a first set of cloud service instances hosted by a first cloud services infrastructure at a first cloud service location. The workload management system determines that a second cloud service location can host a predicted tenant-specific workload. The system obtains weather data for the cloud service locations. Based at least in part on the predicted tenant-specific workload and the weather data for the cloud service locations, the workload management system determines non-carbon costs of hosting and/or migrating the predicted tenant-specific workload while maintaining baseline performance criteria and a carbon cost of hosting and/or migrating. Based at least in part on the calculated costs, the system stores an indication that carbon emissions will be reduced by hosting the predicted tenant-specific workload at the second cloud service location and routes an ongoing workload to the second cloud service location.

### BACKGROUND

Cloud service providers offer tenants the ability to host software workloads on the cloud service provider's infrastructure. The cloud service provider manages the hardware that hosts the workloads, and the cloud service provider can direct what infrastructure is used to host a given workload.

The workloads to the cloud services infrastructure include requests from clients such as users and/or applications for functionality provided by software applications that access data from database systems or other storage resources to provide results for the requests that vary over time, based on the content of the request, and based on the source (e.g., user or application) of the request. The software applications operate using processing resources of the cloud infrastructure to provide the results to the client.

Network hops between clients and the cloud infrastructure cause a delay for the cloud infrastructure to receive the client requests and a delay for clients to obtain results from the client requests. Cloud service providers may host cloud infrastructure resources in locations near clients to reduce the amount of network hops needed to reach the clients. Cloud infrastructure operating in a highly populated area may have high workloads due to the high number of requests coming from clients nearby. These high workloads may impose high demands on local resources, higher energy consumption, and higher inefficiency, resulting in additional expense and additional latency within the cloud infrastructure.

Managing these additional costs is difficult when many of the resulting inefficiencies are due to workloads from multiple tenants supported by multi-tenant cloud infrastructure. For security reasons, individual tenants of a multi-tenant cloud infrastructure cannot determine what activities are being performed by other tenants of the multi-tenant cloud infrastructure.

### BRIEF SUMMARY

In some embodiments, a computer-implemented method includes a workload management system, which monitors a tenant-specific workload for a tenant on a first set of one or more cloud service instances hosted by a first cloud services infrastructure at a first cloud service location. The workload management system determines that a second cloud service location can host a predicted tenant-specific workload based on the tenant-specific workload. The system obtains weather data or other data specific to an environment of the cloud service locations. Based at least in part on the predicted tenant-specific workload and the environment-specific data for the cloud service locations, the workload management system determines a non-carbon cost of hosting and/or migrating the predicted tenant-specific workload while maintaining baseline performance criteria and a carbon cost of hosting and/or migrating the predicted tenant-specific workload for the tenant at either cloud service location. Based at least in part on the calculated costs, the system stores an indication that carbon emissions will be reduced by hosting the predicted tenant-specific workload at the second cloud service location and routes an ongoing tenant-specific workload, corresponding to the predicted tenant-specific workload, to the second cloud service location.

A computer-implemented method includes monitoring a tenant-specific workload for a tenant on a first set of one or more cloud service instances hosted by a first cloud services infrastructure at a first cloud service location, based at least in part on tenant-specific metadata, determining that a second cloud service location, in which a second cloud services infrastructure hosts one or more other cloud service instances, can host a predicted tenant-specific workload based on the tenant-specific workload, obtaining weather data for the first cloud service location and the second cloud service location; based at least in part on the predicted tenant-specific workload and the weather data for the first cloud service location, determining a first non-carbon cost of hosting an the predicted tenant-specific workload while maintaining baseline performance criteria for the tenant by the first cloud services infrastructure at the first cloud service location for a future period of time and a first carbon cost to host the predicted tenant-specific workload for the tenant by the first cloud services infrastructure at the first cloud service location for the future period of time, based at least in part on the predicted tenant-specific workload and the weather data for the second cloud service location, determining a second non-carbon cost of newly hosting the predicted tenant-specific workload while maintaining the baseline performance criteria for the tenant by the second cloud services infrastructure at the second cloud service location for the future period of time and a second carbon cost to newly host the predicted tenant-specific workload for the tenant by the second cloud services infrastructure at the second cloud service location for the future period of time, based at least in part on the first non-carbon cost, the second non-carbon cost, the first carbon cost, and the second carbon cost, storing an indication that one or more conditions are satisfied, wherein the one or more conditions comprise that carbon emissions will be reduced within one or more performance constraints by newly hosting the predicted tenant-specific workload by the second cloud services infrastructure, and routing an ongoing tenant-specific workload corresponding to the predicted tenant-specific workload to a second set of one or more cloud service instances hosted by the second cloud services infrastructure at the second cloud service location.

In a further embodiment, the computer-implemented method further includes, in response to the indication that the one or more conditions are satisfied, checking a workload transition setting to verify whether the ongoing tenant-specific workload should be transitioned automatically when the one or more conditions are satisfied, and based at least in part on determining that the ongoing tenant-specific workload should be transitioned automatically, automatically configuring, without a precondition on receiving user approval, the second set of one or more cloud service instances to store one or more database structures, including one or more particular database structures in memory, for hosting the ongoing tenant-specific workload, wherein the routing the ongoing tenant-specific workload to the second set of one or more cloud service instances is performed automatically in response to a confirmation that the second set of one or more cloud service instances has been configured to store the one or more database structures, including the one or more particular database structures in a memory, for hosting the ongoing tenant-specific workload.

The baseline performance criteria may be determined based at least in part on an agreement to host the tenant-specific workload. The first non-carbon cost may include a first resource operation cost, and the second carbon cost may include a second resource operation cost. In a further embodiment, the computer implemented method may also include obtaining first resource operation information of the first cloud service location, obtaining second resource operation information of the second cloud service location, determining the first resource operation cost based at least in part on the first resource operation information, and determining the second resource operation cost based at least in part on the second resource operation information, wherein the determining the first carbon cost is based at least in part on a first carbon cost of electricity of the first resource operation information, and wherein the determining the second carbon cost is based at least in part on a second carbon cost of electricity of the second resource operation information.

Determining the first carbon cost may also include determining a first carbon cost of electricity for a first energy source, and determining a second carbon cost of electricity for a second energy source. In a further embodiment, the computer-implemented method may also include determining the lower carbon cost of electricity of the first carbon cost of electricity and the second carbon cost of electricity, and storing, within the indication that carbon emissions will be reduced, the lower carbon cost of electricity.

In a further embodiment, the computer-implemented method may also include, based at least in part on the predicted tenant-specific workload and the weather data for the first cloud service location, determining a third carbon cost to continue hosting a second predicted tenant-specific workload for the tenant by the first cloud services infrastructure at the first cloud service location for a second future season of the year, wherein the second predicted tenant-specific workload is different from the predicted tenant-specific workload, based at least in part on the predicted tenant-specific workload and the weather data for the second cloud service location, determining a fourth carbon cost to newly host the second predicted tenant-specific workload for the tenant by the second cloud services infrastructure at the second cloud service location for the second future season of the year, and based at least in part on the first cost of satisfying baseline performance cost criteria, the second cost of satisfying baseline performance cost criteria, the third carbon cost, and the fourth carbon cost, storing a second indication that one or more conditions are not satisfied, wherein the one or more conditions include that carbon emissions will be reduced within one or more performance constraints by newly hosting the second predicted tenant-specific workload by the second cloud services infrastructure for the second future season of the year.

Determining the first carbon cost may also include determining a third carbon cost based on a first source of energy for the first cloud service location, determining a fourth carbon cost based on a second source of energy for the first cloud service location, and storing the lower of the third carbon cost and the fourth carbon cost as the first carbon cost. Determining the second carbon cost may also include determining a fifth carbon cost based on a third source of energy for the second cloud service location, determining a sixth carbon cost based on a fourth source of energy for the second cloud service location, and storing the lower of the fifth carbon cost and the sixth carbon cost as the second carbon cost.

The one or more performance constraints may include a first expected request latency between client requests and the second cloud service location, and determining a non-carbon cost may also include modeling client location clusters, modeling client requests for each location cluster, assigning a weight of requests per location based on a workload volume of each location, determining an aggregate latency for each location cluster, between the location cluster and the second cloud service location, weighting the aggregate latencies based on the weight of requests per location, determining a second expected request latency based on the weighted aggregate latencies, comparing the second expected request latency and the first expected request latency, and storing a difference between the second expected request latency and the first expected request latency in a non-carbon cost.

Determining that the second cloud service location can host the predicted tenant-specific workload may further include checking a table of cloud service locations for the second cloud service location, wherein the table of cloud service locations includes data of at least one of: locations identified by the tenant to be valid locations, locations identified by the tenant to not be valid locations, locations within the same regulatory group, and data of server features at each location.

In a further embodiment, the computer-implemented method may include, before routing the ongoing tenant-specific workload, checking for a second indication that one or more second conditions are satisfied, wherein the one or more conditions comprise that carbon emissions will be reduced for a second predicted workload by hosting the second predicted workload by the second cloud services infrastructure at the second cloud services infrastructure, and comparing the second carbon cost and a third carbon cost to host the second predicted workload by the second cloud services infrastructure at the second cloud service location, wherein the routing the ongoing tenant-specific workload is based at least in part on the second carbon cost being lower than the third carbon cost.

In a further embodiment, before routing the ongoing tenant-specific workload, a second workload of the second tenant is hosted by the second cloud services infrastructure at the second cloud service location, the method further comprising re-routing a second ongoing tenant-specific workload of the second tenant corresponding to the second predicted workload to another cloud services infrastructure other than the second cloud services infrastructure at the second cloud service location to increase an available capacity of the second cloud services infrastructure to handle the ongoing tenant-specific workload for the tenant.

In a further embodiment, the re-routing the second ongoing tenant-specific workload is performed after checking a policy of the second tenant to confirm that the second tenant indicated, in the policy, a preference to move workload of the second tenant if workload of another tenant would result in greater carbon efficiency.

Routing the ongoing tenant-specific workload may include updating an intermediate server between client devices and the second cloud service location to address requests to at least one cloud service instance of the second set of one or more cloud service instances, wherein the updating includes sending an address of the at least one cloud service instance of the second set of one or more cloud service instance to the intermediate server.

The tenant-specific workload may include at least one of, a front-end process, a back-end process, or data processing for a data set. In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

The techniques described above and below may be implemented in a number of ways and in a number of contexts. Several example implementations and contexts are provided with reference to the following figures, as described below in more detail. However, the following implementations and contexts are but a few of many.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a set of operations for implementing certain aspects of a workload management system.

FIG. 2 depicts a simplified diagram of a distributed system for implementing certain aspects.

FIG. 3 illustrates an example graphical user interface that may be used to implement certain aspects.

FIG. 4 depicts a simplified diagram of a distributed system for implementing certain aspects.

FIG. 5 is a simplified block diagram of one or more components of a system environment by which services provided by one or more components of an embodiment system may be offered as cloud services, in accordance with certain aspects.

FIG. 6 illustrates an example computer system that may be used to implement certain aspects.

### DETAILED DESCRIPTION

A workload management system monitors a tenant-specific workload that can be transitioned to a new cloud service location. Based on the tenant-specific workload, the workload management system determines a predicted tenant-specific workload for a future period of time. The workload management system determines that a new cloud service location can host the predicted tenant-specific workload. In one example, the system obtains weather data or other data specific to an environment of the cloud service locations. Based at least in part on the tenant-specific workload and the environment-specific data for the cloud service locations, the workload management system determines (i) a non-carbon cost of hosting the predicted tenant-specific workload while maintaining baseline performance criteria and (ii) a carbon cost to host the predicted tenant-specific workload for the tenant at either cloud service location. Based at least in part on the calculated costs, the system stores an indication that carbon emissions will be reduced by hosting an ongoing tenant-specific workload, corresponding to the predicted tenant-specific workload, at the second cloud service location and routes the workload to the second cloud service location.

In various embodiments, the workload management system is implemented using non-transitory computer-readable storage media to store instructions which, when executed by one or more processors of a computer system, cause display of a user interface and processing of received input for client preferences or selections and/or for displaying results of enforcing the client preferences or selections with respect to workload management. The workload management system may be implemented on a local or cloud-based computer system. The computer system may communicate with client computer systems for measuring performance of various cloud service locations or sets of cloud services infrastructure, such as data centers.

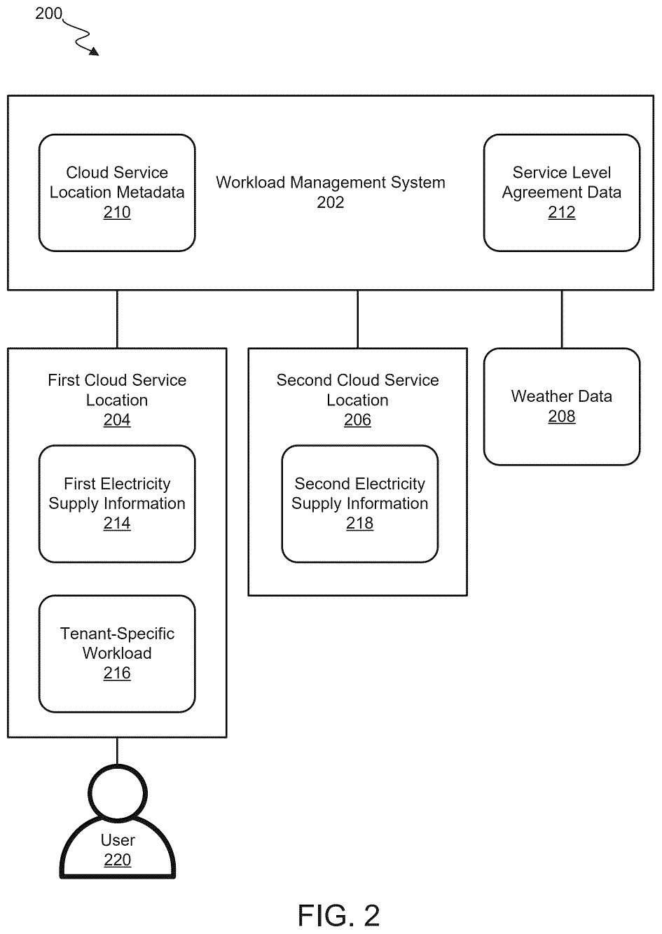

In the example embodiment of FIG. 2, the workload management system 202 is implemented as part of a distributed system 200. The distributed system 200 also includes a first cloud service location 204, a second cloud service location 206, and a weather data 208 which are each in communication with the workload management system 202. The workload management system 202 contains cloud service location metadata 210 and service level agreement data 212. The first cloud service location 204 contains the first electricity supply information 214, which represents data regarding the electricity supply to the first cloud service location 204. The first cloud service location 204 also contains the tenant-specific workload 216 to which the user 220 communicates via the first cloud service location 204. The second cloud service location 206 contains the second electricity supply information 218, which represents data regarding the electricity supply to the second cloud service location 206.

A description of a workload management system is provided in the following sections:
DETERMINING CARBON COSTS
COSTS OF SATISFYING BASELINE PERFORMANCE CRITERIA
LIMITATIONS TO MOVING CLOUD HOST LOCATIONS
WORKLOAD MIGRATION TOOLS AND INTERFACES
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Determining Carbon Costs

Within a cloud services infrastructure, there may be multiple cloud service locations with different capabilities, availability, costs of service, and carbon costs to the service the cloud service location can provide. A cloud services infrastructure may handle cloud services requests at any of the cloud service locations in which the relevant software instances and hardware infrastructure are running or available to configure. The availability of cloud services may depend on the requirements of the specific service, the capabilities and availability of each location, and any governing regulations of the data associated with the service. The cloud service location that one of the cloud service's tenants' workloads is hosted at can therefore be determined with a consideration for the effect that location will have on the carbon cost to host that tenant's workload.

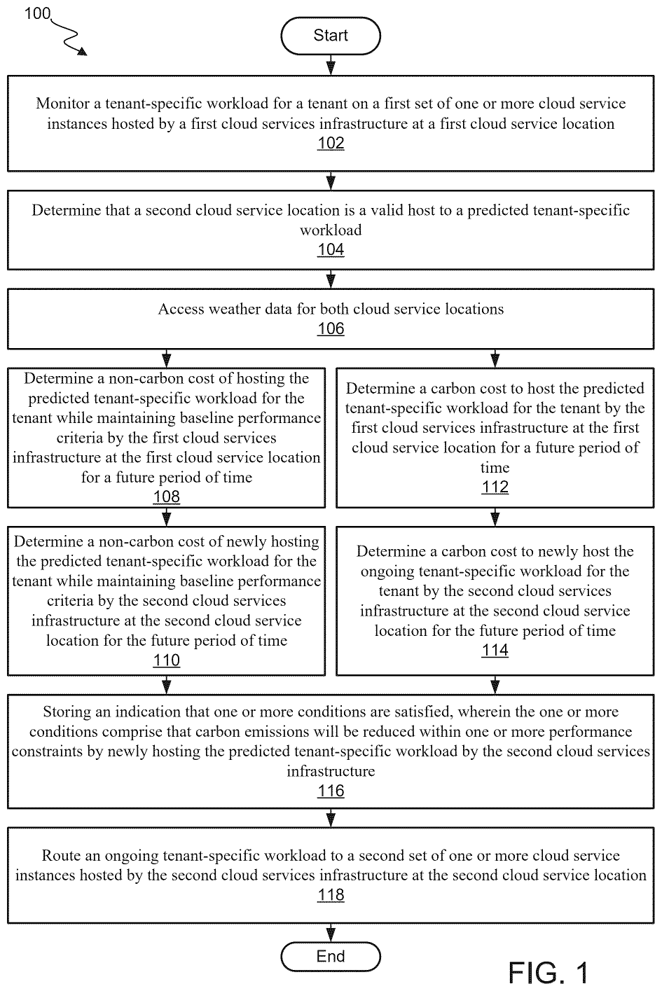

In the example embodiment of FIG. 1, at block 102, a workload management system 202 monitors a tenant-specific workload for a tenant on a set of one or more cloud service instances hosted by a cloud services infrastructure at a cloud service location 204. Monitoring the tenant-specific workload may be performed at a centralized cloud management system or by the local management system for the cloud service location 204 that hosts the tenant-specific workload. There may be multiple workloads for a single tenant or other workloads for other tenants hosted on the same cloud services infrastructure. Monitoring the tenant-specific workload includes measuring aspects of requests to the cloud infrastructure, operation performance by the cloud infrastructure, and/or resource consumption by the cloud infrastructure for which the data and calculations will be made to optimize the management and hosting of that workload.

A workload is handled in an ongoing basis as requests are received by clients. For future periods of time, a predicted workload may be estimated based on the current or past workload. The predicted workload may comprise metadata about an approximated workload, such as resource consumption, time consumption, requests, client locations, communicating timing, etc., and/or may include or be based on actual individual requests that are predicted to be made in the future. The predicted workload may account for trends, for example based on linear regression or logarithmic patterns in data over time, and the trends may be detected on individual data characteristics such that some trends may be trending up and other trends may be trending down. For example, a predicted workload may have a smaller expected amount of resources used per request due to a downward trend in resources used per request but an upward trend in number of total requests. The trends may be combined together for an overall prediction of carbon and non-carbon cost impacts for the predicted workload.

As time progresses to a future period of time for which the predicted workload was specified, the predicted workload approximately becomes the current, ongoing workload for that future period of time if the prediction is approximately accurate. The predicted workload may be approximated based on patterns or statistics detected in one or more past portions of workload. If a decision to transition workload is made, the workload prior to the decision may be unaffected by the transition, but the ongoing workload after the decision and after the transition is initiated or completed may be routed to a new location. The ongoing workload that is routed to the new location may have been approximated at least in part by or otherwise correspond to the predicted workload.

The workload may include a data workload including storing a portion of the data to support the service and/or processing workload including processing requests to use a service and/or access data. The requests may be requests to retrieve or analyze data or to perform other functionality on the server, optionally in communication with other devices. The workload may also include a front-end process, such as a process that communicates directly with a client device or client session. A front-end process may primarily handle requests made by clients and will communicate with a back-end process or access data to handle requests. The workload may also include a back-end process, which may communicate with front-end processes to handle requests and access data to read and write new data based on requests from front-end processes.

Different elements or types of a workload have different carbon costs associated with hosting at a given location. The hosting of front-end and back-end processes may require more processing and thus power draw, therefore the location of these processes can greatly affect carbon cost due to electricity usage. The storage of data may require less electricity consumption than the front-end or back-end processes when already hosted at a given location, however, the carbon cost of migrating data to a new cloud service location may be greater than the carbon cost of migrating the front-end or back-end process.

To determine an estimate of the workload's energy requirements, the workload management system may use historical data of the workload or past similar workloads based on an amount of CPU time spent on request processing per minute or hour, an amount of storage resources used to support request processing per minute or hour, and an amount of energy used per minute or hour to support the CPU time and/or the storage resources. The estimate may also be determined by set parameters for the workload set or agreed by either the cloud service provider or the tenant.

A tenant-specific workload hosted by a cloud services infrastructure may consume a certain amount of storage and/or processing resources to complete client requests, and this certain amount of storage and/or processing resources may be estimated ahead-of-time based on historical uses. To provide this storage and/or processing, the cloud services infrastructure uses an amount of electricity that can be estimated in advance based on the estimated storage and/or processing resources to be used. The cloud services infrastructure can use an estimate of energy usage combined with information of the carbon cost of electricity provided to the cloud services infrastructure to determine a carbon cost associated with a known amount of processing required for any tenant-specific workload the cloud services infrastructure hosts.

### Impact of Weather on Carbon Cost

A carbon cost for electricity at any location can depend on many factors, including the method of generation of that electricity and the impact of the local weather on that generation of electricity. Depending upon the season, a location's carbon cost may vary as the current weather affects how electricity provided to the location is generated. A location may therefore have a more or less favorable carbon cost in certain seasons or may have a more or less favorable carbon cost than other locations in a given season. Carbon cost can also vary at a given location throughout the day, which can make a location have a more favorable carbon cost at certain times of day but not others.

In FIG. 1, at block 106, the workload management system 202 may access the weather data 208 for various cloud service locations in which cloud services infrastructure hosts one or more cloud service instances. Weather data 208 for a first cloud service location 204 and a second cloud service location 206 may be accessed. The first cloud service location is a location at which a cloud service instance of a tenant-specific workload 216 that may be moved is currently hosted. The second cloud service location is a location that the cloud service instance may be moved to.

Based at least in part upon the tenant-specific workload 216 and the weather data 208 for each location, a carbon cost for each location may be determined. In the example embodiment of FIG. 1, at block 112, the workload management system 202 determines the carbon cost to host a predicted tenant-specific workload for the tenant at the first cloud service location 204 for a future period of time. At block 114, the workload management system 202 determines the carbon cost to newly host the predicted tenant-specific workload for the tenant at the second cloud service location 206 for the same future period of time. The determination may include a determination of whether supporting the predicted tenant-specific workload at the second cloud service location would rely on a prior migration, initialization, and/or configuration of supporting resources to the second cloud service location and, if so, the carbon cost of that additional migration, initialization, and/or configuration of supporting resources. For example, the supporting resources may include indexes or other supporting data structures that would be moved to the second cloud service location prior to migrating the workload to the second cloud service location.

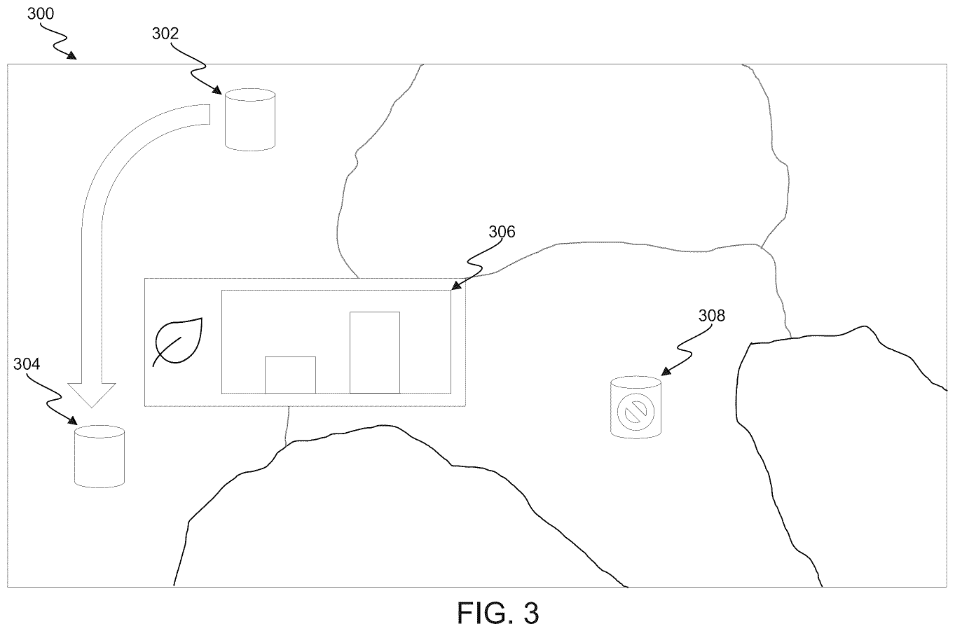

The calculated carbon costs may be displayed to the tenant for approval or suggestion in the case that a carbon cost to host at a new cloud service location is found to be lower than the carbon cost to host at the current cloud service location. An example graphical user interface 300 is presented in FIG. 3. The graphical representation 306 depicts the carbon cost for each cloud service location in question. In this example the tenant may approve the suggestion to newly host the workload as represented by the graphical representation 306 or the graphical representation may depict a decision made by the workload management system, in accordance with the service level agreement with the tenant, to represent the expected carbon cost savings by participating in the workload management system.

The weather data 208 for a cloud service location may detail the predicted weather including, for example, the average sun index and/or the average, high, or low temperatures for that location. The weather data 208 may also include historical data for weather of the same date or time of year or historical averages for any longer period of time such as historical average temperatures for given months or annual seasons. Weather data 208 may be accessed for various lengths of time for any future period of time such as for the next season, the next month, or any other level of granularity or combination of dates. The weather data 208 may also include predictions of changes over historical data or historical averages for any given period of time, including predictions of changes to local weather due to climate change. The weather data 208 can also be more granular, including predictions or historical data at any hour of a day such as average sun exposure at noon in a given season, month, or day.

For greater predictive power of the carbon cost of hosting a cloud service workload, the weather data 208 accessed for any locations whose carbon costs are to be compared may have similarly available historical data, available weather predictions, and/or weather data for the same periods of time at the locations. Weather data for longer periods of time may have greater predictive power in determining future carbon cost. Using longer periods of time for hosting in another location without migrating again due to intermittent weather changes also has the benefit of reducing the impact of the carbon costs of the migration on the overall carbon cost.

A carbon cost newly hosting a cloud service workload to a new location may also include an additional carbon cost required by the migration. Migrating a workload may require additional processing to communicate between the two locations such as to transfer necessary data. Migrating a workload may have an additional carbon cost as a cloud service instance may need to be run at both locations simultaneously to prevent a stoppage in the cloud service workload. Such a requirement can be determined in advance by checking the details of the workload, and can therefore be accounted for in a total carbon cost to host at a new cloud service location.

### Impact of Electricity Generation Mode on Carbon Cost

The carbon cost for a given cloud service location can also vary depending on properties of the location such as what electricity providers can be selected to provide the electricity used or expected to be used. Information used in determining a carbon cost for a given location could also include which energy provider will or could provide electricity for powering the workload in question, the carbon cost per unit of electricity of the energy provider's supply, and whether there are contractual limitations that will ensure what energy provider or method of electricity generation will be used to service the workload in question. In the case that a cloud service location is supplied with electricity from multiple forms of electricity generation, the carbon cost may be calculated using the lower, higher, average, or weighted average (based on the relative contribution of each) of the two carbon costs, or if historical data is available for usage of the different electricity sources, the carbon cost may be calculated using a weighted average of the carbon costs of the different electricity sources' carbon cost of electricity.

A calculation of carbon costs for a future period of time may factor in known or predicted changes to the electricity service at a given location. For example, a location may not currently have a connection to electricity supply from a renewable electricity source, but there may be a known plan to add solar power to the location's electricity supply. The carbon cost may be calculated to include the expected carbon cost of solar power for any time after the expected date that the solar power will be available. Changes to the electricity supply at a given location may also factor in detrimental effects such as a lowering efficiency of electricity supply or generation. As an example, the calculation of carbon cost may include the expected power generation of solar power given the efficiency of the solar power infrastructure as calculated by the infrastructure's age. A calculation of carbon costs may also include how changes to the infrastructure for added performance may positively or negatively affect the carbon cost of electricity at that location. For example, a cloud service location that has plans to add further processing capacity may also require a change in electricity service that changes the apportionment of what sources of electricity generation are used.

Different sources of electricity may have different carbon intensities, or amounts of carbon dioxide produced per unit of electricity generated by the energy source. Example carbon intensities of different example energy sources include coal at approximately 900 g CO₂/kWh, oil at approximately 800 g CO₂/kWh, natural gas at approximately 400 g CO₂/kWh, nuclear at 12 g CO₂/kWh, and wind, solar, or hydroelectric at approximately 0 g CO₂/kWh. The energy provider or relevant governmental entity can supply carbon emissions per energy provider and per mode of energy, and such information may be stored in a table to override a default assumption that coal energy is being used.

The carbon cost of a process using a mode of electricity may be determined based on the energy consumption of all devices supporting the process based on a portion of the device usages and correspondingly energy consumption attributable to the process as compared to other processes supported by the devices. The energy consumption, for example 1000 kWh, may be multiplied by the carbon intensity of the corresponding energy source to determine the total carbon footprint for the energy source. For example, using coal energy, 1000 kWh of usage contributes to 900 kg CO₂ in the atmosphere. Data centers with more equipment supporting more processes may consume more energy that is attributed to the consuming processes. Energy is consumed by a data center even when there is little or no active workload, and the impact of adding workload to the data center may reduce the carbon footprint per workload unit for that datacenter.

Energy consumption may vary throughout the day, and the workload may have an energy profile based on how much energy is required to support the workload at different times of the day. In addition to using the energy profile to determine carbon costs, the energy profile may be used to offload certain tasks that are not time sensitive, such as backup tasks, update tasks, and other maintenance tasks, to energy efficient times.

### Impact of Communication Distance or Network Hops on Carbon Cost

The carbon cost of servicing a request from a client of the tenant-specific workload depends upon the amount of computation required for processing the request and the distance or number of network hops between the client and the cloud service location hosting the tenant-specific workload. When a client sends a request, that request contains the address of the cloud service location hosting the tenant-specific workload that the request seeks to communicate with, however, the request is not directly sent to the cloud service location. The request must first traverse a number of network hops between servers in the Internet, which each direct the request to the next closest server to the destination. The number of network hops required tends to increase as the client increases in distance from the cloud service location, therefore the carbon cost tends to increase with distance between the client and the cloud service location.

The determination of the carbon cost of network hops to users of the workload may be simplified by first analyzing the locations of known users of the workload or modeling client requests by location and setting one or more weighted average locations of users as a location cluster. For each location cluster, an aggregate number of network hops or a number of network hops to a regional server that services the location cluster may be determined. A weighted average number of network hops may then be determined by assigning weights to the number of network hops of each location cluster by the volume of client requests for that location cluster and calculating the average number of network hops based off the weighted number of network hops. The carbon cost of hosting at a cloud service location may then be determined to include an average carbon cost of a network hop multiplied by the average number of network hops to a given cloud service location.

The determination of the carbon cost of network hops to users of the workload may also be simplified by first determining each of the regional servers through which client requests travel. The workload management system may then determine a number of network hops between the first cloud service location and the regional server with the greatest number of client requests serviced through it. The number of network hops between the second cloud service location and the same regional server may then be determined and compared with the number of network hops to the first cloud service location. The carbon cost savings by newly hosting the tenant-specific workload may be determined to also include the average carbon cost of a network hop multiplied by the difference in the number of network hops between the regional server and each of the cloud service locations less an average increase in network hops for clients whose requests do not traverse the regional server.

### Impact of Extending Cloud Services at a Cloud Service Location to Overflow Infrastructure

As a workload expands, it may generate a demand that is greater than the cloud services infrastructure that currently hosts the workload can supply. In such cases, instances of the workload must be created at overflow infrastructure to service all of the workload. The workload management system may, when calculating carbon costs to host at a given cloud service location, determine a probability that the workload will require expansion to overflow infrastructure based on data of the tenant-specific workload and availability of infrastructure at the cloud service location. The probability that the workload will expand beyond the availability of the cloud services infrastructure in question may be determined based on an average expansion of the workload for a given period of time, the current size of the workload, and the current availability at the cloud service location. The probability that the workload will require expansion to overflow infrastructure may then be used to weight the added carbon cost of servicing that overflow workload at the overflow infrastructure when including in the total carbon cost of hosting the workload at a given cloud service location. In determining the carbon cost of servicing overflow workload at an overflow infrastructure, the workload management system may apply the same analysis of carbon and non-carbon costs to determine a best overflow infrastructure as if the overflow workload were the workload in question. The carbon cost of hosting the overflow workload at the best overflow infrastructure may then be included in the total carbon cost of hosting.

Non-Carbon Costs of Hosting while Maintaining Baseline Performance Criteria

Hosting of a specific cloud service workload at a given cloud service location has various non-carbon cost associated that include, for example, the monetary cost of electricity for performing the processing required, the latency experienced by the clients or parts of the service due to its use of the cloud services infrastructure, and the limitations of available computational and storage resources at that location. A cloud service workload may be comprised of a front-end process, a back-end process, the data used by either process, and the storage required by either process. Different elements of a workload have different performance and resource costs associated with hosting at a given location.

A cloud service workload may have baseline performance criteria, an average performance requirement, and a maximum expected performance requirement. Baseline performance criteria may include max network-side or client-to-server latency, max server-side latency such as latency created by communications between different cloud services infrastructure, and/or a minimum server processing or storage requirement. The baseline performance requirement may be determined by checking a set of requirements set by the tenant, such as may be in service level agreement data 212. Such data would set, as baseline performance criteria, how much storage or processing is required for the workload, or what maximum server-side or network latency can be tolerated to still be compliant under the service level agreement. To avoid breach of the service level agreement, baseline performance criteria should be maintained, and a workload should not be hosted in a way that would not meet baseline performance criteria. To determine an estimate of the workload's average performance requirements, the method may use historical data of past similar workloads. The estimate may also be determined by set parameters for the workload as determined by either the cloud service provider or the tenant, particularly the minimum or maximum required storage, number of CPUs, and amount of memory. Such information may be stored with the cloud service instance of the tenant-specific workload 216 or within the workload management system, such as in service level agreement data 212. The workload management system 202 may consider cloud service locations with available resources to satisfy the minimum or average performance requirements as baseline performance criteria.

### Monetary Cost of Electricity

The hosting of front-end or back-end processes may require more processing whereas the hosting of the data used by a front-end or back-end process may have more communication processes. These different applications will result in a different power demand. As a result, the location of these processes can greatly affect monetary cost due to electricity usage. The workload management system may calculate, as part of the non-carbon cost, the monetary cost of electricity by multiplying the expected power usage for the future time period, as obtained from the tenant-specific workload 216, by the cost of electricity from the cloud service location's electricity supply information 214 or 218. The monetary cost for each cloud service location can then be presented to be compared by the tenant or checked against a limit for monetary costs such as within the service level agreement data 212 to determine if the cost exceeds criteria.

The storage of data may require less electricity consumption than the front-end or back-end processes when already hosted at a given location, however, the energy requirement and monetary cost of migrating data to a new cloud service location may be greater than the energy requirement and monetary cost of migrating the front-end or back-end process. Data may not need to be relocated with a front-end or back-end process, and in some cases due to data redundancy across multiple cloud service locations, there may not be an added cost to migrate the front-end or back-end processes to another location with the same data duplicated in its data storage. Calculations of future monetary costs may also include expected changes to the infrastructure of the cloud service location in question. Expected changes such as an increase or decrease in the cost of electricity supply due to raising prices or a change to a different energy provider may be included in the calculation for monetary costs of future periods of time affected by that change to electricity supply cost.

The monetary costs may be determined based on the energy and/or other resources consumed by each process involved in migrating and/or hosting the workload, as a portion of the overall cost of running devices supporting the migration and/or hosting of the workload relative to other processes supported by the devices. The resources consumed may be multiplied by the cost of resources, resulting in the monetary cost. Different modes of energy production may have different monetary costs per unit of energy consumed, and the monetary cost may be dependent on the mode of energy used at the device location.

### Negative Impacts to Performance

The capabilities and geolocation of a cloud service location also will affect the performance of a front-end or back-end process, therefore there may be a performance cost such as added network latency at a new cloud service location. Hosting a front-end process or a back-end process may also have an added performance cost of server-side latency if they are hosted at a different cloud service location as the data or storage that those processes need to access. Server-to-server latency between cloud service locations may be stored as a table or other data structure to simplify the calculation of the performance cost of latency when calculating a non-carbon cost that includes communicating between cloud service locations. This table of server-to-server latencies between cloud service locations could be determined by historical data of the latency of past communications between two locations or by running a real-time check of the current latency between the two locations.

The determination of the performance cost of network latency to users of the workload may be simplified by first analyzing the locations of known users of the workload or modeling client requests by location and setting one or more weighted average locations of users as a location cluster. For each location cluster, an aggregate network latency may be determined for latency between the location cluster and the second cloud service location 206. A weighted average client network latency may then be determined by assigning weights to the network latencies of each location cluster by the volume of client requests for that location cluster and calculating the average latency based off the weighted latencies.

The calculation of performance costs may account for an expected change to the infrastructure available at the cloud service location in question. For example, the cloud service location may be expected to change networking infrastructure to a new generation of technology that would reduce server-side latency or to add new processors that perform operations faster than prior infrastructure. Such changes may be used as the expected infrastructure capabilities available for the future period of time if the changes are expected to be made prior to or during the future period of time.

### Elasticity of Cloud Service Capabilities

As noted above, a workload may have an expected maximum performance requirement pre-determined in either the tenant-specific workload 216 or within service level agreement data 212. A workload may also have a future expected performance requirement for a future period of time, and which may be defined within service level agreement data 212. Though a cloud service location may be able to supply computational ability or storage space equal to the workload's current baseline or average performance requirements, it may not be able to meet a workload's expected maximum or future performance requirements. A calculation of non-carbon cost(s) may include the elasticity of the cloud service location's capabilities.

The elasticity of cloud service capabilities may be determined by calculating the current available resources at the cloud service location in question that are either not currently used by the tenant-specific workload or would not be used by the tenant-specific workload after newly hosting at the cloud service location. Such calculation may consider expected changes to the cloud service location's infrastructure such as additional storage or processing power. The elasticity of cloud service capabilities may be calculated for both the current cloud service location hosting a tenant-specific workload and a new cloud service location to host the workload. In this example, the new cloud service location may be able to meet the base performance criteria, however, it may not be able to meet a future performance criteria if the workload were to grow in demand. The elasticity of cloud service capabilities may be compared to a pre-determined requirement or may be displayed to the tenant to consider in approving hosting a tenant-specific workload at a new location.

In the example embodiment of FIG. 1, at block 108, the non-carbon cost(s) are determined for continuing to host a predicted tenant-specific workload while maintaining baseline performance criteria by a first cloud services infrastructure at a first location for a future period of time. Block 108 may involve accessing data representing the baseline performance criteria such as an expected latency, expected cost of service, or specifications for the equipment needed for the workload such as number of processors, amount of memory available, or storage space required. Data representing the baseline performance criteria may be stored as service level agreement data 212, derived from the language of a service level agreement with the tenant. At block 112 of the example embodiment, a second non-carbon cost(s) is determined for newly hosting the predicted tenant-specific workload while maintaining baseline performance criteria for the tenant by a second cloud services infrastructure at the second cloud service location for the same future period of time. Therefore, the non-carbon cost(s) associated with each possible location may be compared, presented to the tenant, or analyzed against performance constraints. The non-carbon cost(s) associated with any given cloud service location may be determined based, at least in part, on the tenant-specific workload in question or details of the workload. The determination may also be based in part on details of the cloud service location such as capabilities of the location, distance or server-side latency between the location and another location, distance or network latency between the location and users of the cloud service, availability of service at the location, or costs of migrating or establishing service at the location. The determination may include a determination of if any other data or processes associated with the workload must be migrated as well to be hosted at the same cloud service location and the cost of that additional migration. The determination may consider whether the location contains any amount of the required data for a front-end or back-end process to run and the lower performance cost of utilizing the data stored within the same location as the newly hosted process.

### Limitations to Moving Cloud Host Locations

Depending on the workload, moving workloads to other cloud host locations may, if completed, involve the migration of data in a way that would conflict with regulations. Some regulations, such as the General Data Protection Regulation (GDPR) in the European Union, limit where client data can be moved. The GDPR regulates the location of data processing or transfer for data involving European entities to not just the European Union, but also certain regions within the European Union. Such regulatory restrictions may be applied as filters in determining possible alternative cloud service locations, and reasons for the filters may be displayed to a client prior to moving a workload between locations. In one embodiment, if some filters are applied as relevant to the migration and other filters are not applied, as being not relevant to the migration, the filters that are not applied may be displayed to the client prior to moving the workload as a reminder that the workload management system is unaware of any potential legal or regulatory violations but that certain datasets within the workload may have characteristics unknown to the workload management system.

A tenant of a cloud service often has a service level agreement (SLA) with the cloud service provider, detailing requirements of hosting their cloud service workloads. An SLA may create additional limitations to be considered in determining what to indicate in a calculation of carbon costs and non-carbon costs. The SLA may permit a cloud service provider to newly host a workload automatically upon the indication of a reduced carbon cost, possibly within certain parameters of baseline performance or resource cost so as to not increase other costs too much in favor of a reduced carbon cost. Such an SLA may also indicate a given target or upper limit of carbon cost for a given period of time that the cloud service provider can host workloads at a new location to achieve such a carbon cost. The SLA may indicate that the tenant should only be shown an indication of decreased carbon costs if baseline performance criteria are met, or if there is a performance cost or resource cost below a certain threshold. The SLA may instead prohibit the hosting of a workload at a new location without prior approval upon the indication of the reduced carbon cost, such that the tenant may make a decision with knowledge of the carbon costs and non-carbon costs. The SLA may also include a different price to host a service for different geographic regions or at different cloud service locations. In this example, the different cost to host should be included in the resource costs of hosting at a new cloud service location with a new cost to host.

The tenant may also select, either via language in an SLA or via a selection interface, certain regions or cloud service locations from which a workload may be permitted or prohibited from being hosted. Such choices can be stored as service level agreement data 212 as list data or as metadata of a table of locations, such as a table of latencies between locations. The stored location selection data can then be referenced in future determinations of possible cloud service locations to prohibit from determining the carbon cost of hosting at a prohibited location or to limit calculations of carbon costs to only those permitted locations.

In the example embodiment of FIG. 1, at block 104, the workload management system 202 may determine whether an alternate cloud service location is a valid host to a predicted tenant-specific workload. In block 104, the workload management system may check any number of requirements for the tenant-specific workload, such as regulatory or performance constraints. The workload management system 202 may check service level agreement data 212 for restrictions imposed by the tenant such as cloud service locations that the tenant has explicitly allowed its workload to be hosted at or prohibited its workload to be hosted at. The service level agreement data 212 may also contain restrictions such as whether a front-end or back-end process can be hosted at a different location than the location that the data it references is hosted at. To determine the related processes or data that relate to the tenant-specific workload 216, the workload management system 202 may also check cloud service location metadata 210 that may contain the locations of other processes or data. The cloud service location metadata 210 may also be referenced without the service level agreement data 212, to determine, without input from the tenant, which cloud service locations are valid locations to host the predicted tenant-specific workload based on local regulations.

At FIG. 1, block 116, the workload management system may, when calculating a carbon cost and non-carbon cost of any number of locations, store an indication that hosting of a predicted workload at a new cloud service location will have a reduced carbon cost or non-carbon cost. The indication may then be presented to the tenant such that they are able to decide whether to host the predicted workload at a new location based on the non-carbon cost and carbon cost of hosting at each cloud service location. The indication may be used to generate a graphical representation of the carbon cost savings, such as by a representative display of total tons of CO₂ that is saved relative to the total tons of CO₂ produced with the current workload. Whether automatically upon the indication or after approval by the tenant, the workload management may, as in FIG. 1, block 118, route an ongoing tenant-specific workload, corresponding to the predicted tenant-specific workload, to a second set of one or more cloud service instances hosted by the second cloud services infrastructure at the second cloud service location.

In an alternative embodiment, after calculating the carbon cost and non-carbon cost for newly hosting a predicted workload at a new location and for continuing to host that predicted workload at the original location, the workload management system may determine that one or more conditions are satisfied and automatically host the predicted workload at the new location. In this example, the workload management system may first check a workload transition setting that can enable or disable the automatic transition of the workload.

When transitioning a workload to another cloud service location, some data may be required at the new cloud service location, particularly some data currently stored in memory at the first cloud service location. When automatically transitioning an ongoing tenant-specific workload, the workload management system may also automatically configure the set of one or more cloud service instances, that the workload is to be transitioned to, to store one or more database structures for the tenant-specific workload. This step may have a precondition requiring user approval for some or all data transfers, which will stop the workload management system from automatically moving the database. As some data, such as some data stored in memory, are necessary for the functioning of the workload, the routing of the ongoing tenant-specific workload may be delayed or only performed in response to a confirmation that the set of one or more cloud service instances for the workload to be transitioned to has been configured to store the database structure.

Transitioning a workload may also require the routing of client requests to the new cloud service location. The workload management system 202 may update an intermediate server between client devices and the new cloud service location to address requests to at least one cloud service instance of the new cloud service instances at the new cloud service location. Updating the intermediate server may include sending an address of the at least one cloud service instance to the intermediate server.

Alternatively, the workload management system may obtain, from the workload, the origin point for the data within the workload, which may be distinct from the first cloud service location 204. The workload management system may then compare this location to a table of possible cloud service locations for data of the origin point. In this example, abiding by the restrictions of a regulation is carried out by following the data of the table, as the limitations of the regulation are written into the table data.

In some cases, there may be two tenants that are seeking to reduce their carbon costs and whose use of a lower carbon cost cloud service location is mutually exclusive. In such instances the workload management system may reference a ranked list of tenants by order of preference or priority to determine which tenant is given the lower carbon cost service. Alternatively, the system may compare the carbon costs and non-carbon costs to determine which tenant receives a greater benefit of cost reduction or which tenant would experience the least increase in non-carbon costs for hosting at the lower carbon cost location. In this example, after calculating the carbon cost of newly hosting the predicted tenant-specific workload, the carbon cost may be compared with a pre-calculated carbon cost for the other tenant's workload, that may be stored in its own indication of reduced carbon emissions. In this example, the non-carbon cost to newly host the predicted tenant-specific workload may be simplified by referencing a weighted table of tenants that indicates their preferred cloud service locations as determined by distance of users of that workload to each location. In yet another alternative, the use of the lower carbon cost location by one client may be recorded in a table that can be referenced for future conflicts between tenants, such that a tenant who has not been awarded the lower carbon cost location in past conflicts may be awarded the lower carbon cost location in future conflicts.

In another example, a cloud service location that does not currently have availability for a first workload may still be used to determine if newly hosting at this location would reduce carbon costs if there is at least one second workload at that location, possibly belonging to another tenant, that can be moved (e.g., by moving ongoing second workload based on expected resource usage determined using patterns detected in past second workloads). In this example, the workload management system may determine the costs of newly hosting the first workload and the costs of newly hosting a second predicted workload, based on the second workload, to any other available cloud service location. If the carbon cost reduction of newly hosting the first workload does not outweigh the carbon cost increase of newly hosting the second predicted workload, the cloud service location will not be indicated for the first workload as a possible cloud service location. In such an example, the tenants may be able to elect, in an SLA, that their workload will not be hosted at a new location to prefer a client with a greater carbon cost reduction and/or that their workloads will be moved to a new location if another more carbon friendly workload is available and needs space at a currently used location.

In one example, the workload management system may identify a front-end or back-end process, hosted at a first cloud service location, as having a reduced carbon cost at a second cloud service location for a future period of time. The workload management system may, in determining the carbon cost for hosting the front-end or back-end process, identify a set of data associated with that process stored at either the second cloud service location or a third cloud service location, such as a backup data or redundant data storage. The storage of this backup data or redundant data may be for the purposes of a cloud backup service that synchronizes the data between the cloud host location and the cloud backup location. The calculation of the carbon cost of hosting the front-end or back-end process may be based, at least in part, on a reduction of the distance between the second cloud service location and the cloud service location hosting the backup or redundant data, especially in the case that it is hosted at the second cloud service location. The workload management system may also store an indication that newly hosting the data set to the second cloud service location will create a greater reduction in carbon cost to host the front-end or back-end process should it ever be moved to the second location.

In another example, the workload management system may identify a first data set, hosted at a first cloud service location, as relating to a front-end or back-end process hosted at a second cloud service location. The workload management service may determine the carbon cost of migrating and hosting the first data set at the second cloud service location or a third cloud service location that is closer to the second cloud service location. The workload management system may also determine a carbon cost of continuing to host the first data set at the first cloud service location, which may include the carbon cost of communications between the second cloud service location and the first cloud service location that hosts the first data set or a fourth cloud service location that hosts a second data set. In this example, one of the data sets may be the data set currently used by the front-end or back-end process and the other data set may be a backup or redundant data set. The workload management system may then store an indication that newly hosting the first data set to the second or third cloud service location will create a greater reduction in carbon cost for hosting the workload.

In another example, the workload management system may identify a front-end or back-end process, hosted at a first cloud service location, as having a reduced carbon cost at a second cloud service location for a future period of time, starting at a date beyond which the process will not depend or will infrequently depend on data at a current cloud service location. In this example, the process is structured such that it may depend only or primarily on newly generated or gathered data from the future period of time, so the added carbon cost or non-carbon cost of migrating the data if the process were to be moved before the future period of time is no longer considered in the cost of newly hosting the process to another cloud service location.

### Workload Migration Tools and Interfaces

The method or system described herein, may be implemented as a back-end process to provide data to a graphical user interface for tenants of a cloud service provider that tenants may use to manage the hosting of their workloads with the cloud service provider. An example of such a graphical user interface is depicted in FIG. 3. The graphical user interface 300 displays the first cloud service location 302 which currently hosts a tenant-specific workload. The workload management system suggests that hosting the predicted tenant-specific workload corresponding to the tenant-specific workload at a future period of time at a second cloud service location 304 will provide a lower carbon cost as presented in the carbon cost graphical representation 306. Within this graphical representation, the third cloud service location 308 represents a cloud service location that is not considered for hosting the workload either because it does not provide a lower carbon cost, does not allow the satisfaction of baseline performance criteria, or is prohibited from hosting the workload either by choice of the tenant or by other external requirements such as regulation.

The workload management system may perform the analysis of carbon and non-carbon costs at any time, however, constantly checking every workload may be inefficient. The workload management system may perform the analysis of carbon and non-carbon costs at regular intervals or a designated time relevant to when carbon costs are expected to change, such as the changing of seasons. The workload management system may perform the analysis at such regular intervals (e.g., daily, weekly, monthly, quarterly, annually) or at designated times (e.g., off-peak times such as 2 a.m. locally) in response to an indication, such as within their service level agreement, that the tenant wishes to reduce carbon costs.

In the same or a different embodiment, the workload management system may perform the analysis whenever there is a change to the workload, such as an increase in the size of the workload, as changes to the workload may impact the extent of benefits to carbon costs.

In the same or a different embodiment, the workload management system may perform the analysis whenever there is a change: to weather forecasts a threshold distance from previously forecasted weather, to electricity costs a threshold distance from previously forecasted electricity costs, to modes of electricity being used at a cloud service location from previously expected modes to be used, to aggregate or average client request locations for cloud services a threshold distance from previously forecasted client request locations, to an availability of bandwidth or other resources at a cloud service location (for example, due to workload migrating away from or to the cloud service location for another tenant, or due to other fluctuation in workload at the cloud service location), or any other factor that may impact carbon cost and/or performance cost. Such analyses may be performed synchronously to detecting the corresponding change, such that the workload management system adapts to changing environments.

The workload management system may perform the analysis in response to a change to weather forecasts for a region containing a cloud service location. The workload management system may monitor weather forecasts at a regular interval or may analyze weather forecasts whenever supplied with new data, at which time it may update its record of weather forecasts for use as weather data in the analysis, and to compare the new weather forecasts to the old weather forecast and determine a number of workloads impacted by the change. The workload management system may only run the analysis when the change in weather forecast exceeds a threshold value, such as a change in the amount of expected sunlight over a region large enough to require supplementing solar energy with fossil fuel energy. In the case that the workload management system determines that the change in weather forecast exceeds a threshold, the workload management system may run the analysis for any combination of workloads either currently hosted at cloud service locations inside or outside of the region of the weather forecast. For example, the analysis may be run only on workloads hosted within the region of the changed weather forecast in the case that the change in weather forecast negatively impacts carbon costs. In another example, the analysis may be run on any workload that may be newly hosted at a cloud service location within the region in the case that the change in weather forecast positively impacts carbon costs within the region or in the case that an affected cloud service location is determined to have availability. The analysis may also be run for any workload where the analysis was previously run for the cloud service locations affected, particularly for workloads where an indication has been stored that carbon costs will be reduced by newly hosting that workload. For workloads where an indication of reduced carbon costs has been stored, the indication may be updated or removed after performing the analysis again for the same two cloud service locations.

The workload management system may perform the analysis in response to a change to electricity costs. The workload management system may monitor electricity costs at a regular interval or may analyze electricity costs whenever supplied with new data, at which time it may update its record of electricity costs and to compare the new electricity costs to the old electricity costs and determine if a threshold distance from previously forecasted electricity costs has been reached. In the case that the threshold distance from previously forecasted electricity costs has been reached, the workload management system may perform the analysis for any potentially affected workloads. For example, the analysis may be run for any workload that contains within its service level agreement data a target or threshold cost of electricity. The analysis may also be run for any workload where the analysis was previously run for the cloud service locations affected, particularly for workloads where an indication has been stored that carbon costs will be reduced by newly hosting that workload or where it was previously determined that carbon costs would be reduced by newly hosting the workload, but the previous cost of electricity for the given cloud service location was above a threshold. For workloads where an indication of reduced carbon costs has been stored, the indication may be updated or removed after performing the analysis again for the same two cloud service locations and determining if the new cost of electricity is not above a threshold.

The workload management system may perform the analysis in response to a change in the modes of electricity generation used or expected to be used to supply electricity to a cloud service location. The workload management system may, upon receiving information of a change in electricity suppliers or method of electricity generation supplied to a given cloud service location, perform the analysis for any combination of workloads either currently hosted or not currently hosted at the affected cloud service location. For example, the analysis may be performed for any workload currently hosted at the cloud service location when the location is no longer receiving electricity from a lower carbon cost generation method. In another example, the analysis may be run on any workload that may be newly hosted at the affected cloud service location in the case that the change in electricity service positively impacts carbon costs for the cloud service location or in the case that the cloud service location is determined to have availability. The analysis may also be run for any workload where the analysis was previously run for the cloud service locations affected, particularly for workloads where an indication has been stored that carbon costs will be reduced by newly hosting the workload at the affected cloud service location. For workloads where an indication of reduced carbon costs has been stored, the indication may be updated or removed after performing the analysis again for the same two cloud service locations and determining the new carbon and non-carbon costs for hosting at the affected cloud service location.

The workload management system may perform the analysis in response to a change to aggregate or average client request locations. The workload management system may regularly monitor client request locations and model and aggregate or average client request location or may be supplied with client request locations by a cloud services infrastructure. The workload may compare the aggregate or average client request locations to previously determined aggregate or average client request locations to determine if a threshold distance has been reached, in which case the workload management system may perform the analysis for any combination of workloads either currently hosted or not currently hosted at the affected cloud service location. The workload management system may also sort the client requests by workload requests to determine a number of workloads affected for a given cloud service location. For example, the analysis may be run for any workload currently hosted at the cloud service location when the aggregate or average client location moves away from the cloud service location. In another example, the analysis may be run for any workload not currently hosted at a cloud service location that the aggregate or average client location has moved closer to. The analysis may also be run for any workload where the analysis was previously run for the cloud service locations affected, particularly for workloads where an indication has been stored that carbon costs will be reduced by newly hosting that workload. For workloads where an indication of reduced carbon costs has been stored, the indication may be updated or removed after performing the analysis again for the same two cloud service locations and determining the new carbon and non-carbon costs for hosting at the affected cloud service location, given the change in average or aggregate client location.

The workload management system may perform the analysis in response to a change to an availability of bandwidth or other resources at a cloud service location. The workload management system may, upon receiving information of an expansion of available bandwidth or resources at a cloud service location or upon newly hosting a workload at a new cloud service location, perform the analysis for any workload that may be newly hosted at the cloud service location with new availability or resources. For example, the workload management system may, in response to routing an ongoing workload to a new cloud service location, perform the analysis with any workload not currently hosted at the cloud service location that the previous workload was hosted at. In another example, the analysis may be performed, upon receiving an indication that a workload has or is expected to reduce in size, for any workload not currently hosted at the same cloud service location as the reducing workload and whose resource or bandwidth requirement is less than or equal to the new availability at the cloud service location. The analysis may also be run for any workload where the analysis was previously run for the cloud service locations affected, particularly for workloads where an indication has been stored that carbon costs will be reduced by newly hosting that workload newly hosting the workload at the affected cloud service location. For workloads where an indication of reduced carbon costs has been stored, the indication may be updated or removed after performing the analysis again for the same two cloud service locations and determining if the cloud service location can still host the new workload.

The workload management system may also perform the analysis whenever the tenant accesses a portal for managing their workloads such as the graphical user interface 300. Performing the analysis only when a management system is accessed by the tenant prevents unnecessary calculations and provides the tenant with a calculation of carbon and non-carbon costs with the most up-to-date data.

In various embodiments, in response to determining that a workload is to be migrated at a particular time or otherwise in the future, the workload management system triggers a notification (e.g., e-mail, text message, pop-up notification, or other UI notification) to one or more users registered to receive information about upcoming workload migrations. In a particular embodiment, the workload management system triggers a first notification to a first user corresponding to a tenant administrator and a second notification to a second user corresponding to a cloud services administrator, notifying both parties of the upcoming workload change.

### Computer System Architecture

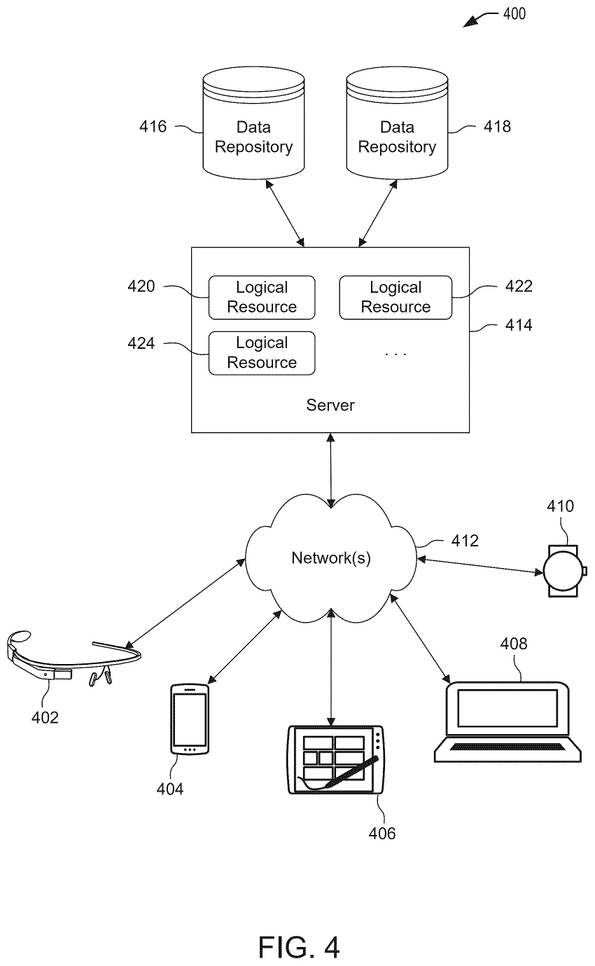

FIG. 4 depicts a simplified diagram of a distributed system 400 for implementing an embodiment. In the illustrated embodiment, distributed system 400 includes one or more client computing devices 402, 404, 406, 408, and/or 410 coupled to a server 414 via one or more communication networks 412. Clients computing devices 402, 404, 406, 408, and/or 410 may be configured to execute one or more applications.

In various aspects, server 414 may be adapted to run one or more services or software applications that enable techniques for workload management.

In certain aspects, server 414 may also provide other services or software applications that can include non-virtual and virtual environments. In some aspects, these services may be offered as web-based or cloud services, such as under a Software as a Service (SaaS) model to the users of client computing devices 402, 404, 406, 408, and/or 410. Users operating client computing devices 402, 404, 406, 408, and/or 410 may in turn utilize one or more client applications to interact with server 414 to utilize the services provided by these components.

In the configuration depicted in FIG. 4, server 414 may include one or more components 420, 422 and 424 that implement the functions performed by server 414. These components may include software components that may be executed by one or more processors, hardware components, or combinations thereof. It should be appreciated that various different system configurations are possible, which may be different from distributed system 400. The embodiment shown in FIG. 4 is thus one example of a distributed system for implementing an embodiment system and is not intended to be limiting.

Users may use client computing devices 402, 404, 406, 408, and/or 410 for techniques for workload management in accordance with the teachings of this disclosure. A client device may provide an interface that enables a user of the client device to interact with the client device. The client device may also output information to the user via this interface. Although FIG. 4 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban Meta® smart glasses, Snap® Spectacles, and other devices. Gaming systems may include various handheld gaming devices, Internet-enabled gaming devices (e.g., a Microsoft Xbox® gaming console with or without a Kinect gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 412 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 412 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 414 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 414 can include one or more virtual machines running virtual operating systems, or other computing architectures involving virtualization such as one or more flexible pools of logical storage devices that can be virtualized to maintain virtual storage devices for the server. In various aspects, server 414 may be adapted to run one or more services or software applications that provide the functionality described in the foregoing disclosure.

The computing systems in server 414 may run one or more operating systems including any of those discussed above, as well as any commercially available server operating system. Server 414 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBMX® (International Business Machines), and the like.

In some implementations, server 414 may include one or more applications to analyze and consolidate data feeds and/or event updates received from users of client computing devices 402, 404, 406, 408, and/or 410. As an example, data feeds and/or event updates may include, but are not limited to, blog feeds, Threads® feeds, Twitter feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 414 may also include one or more applications to display the data feeds and/or real-time events via one or more display devices of client computing devices 402, 404, 406, 408, and/or 410.

Distributed system 400 may also include one or more data repositories 416, 418. These data repositories may be used to store data and other information in certain aspects. For example, one or more of the data repositories 416, 418 may be used to store information for techniques for workload management. Data repositories 416, 418 may reside in a variety of locations. For example, a data repository used by server 414 may be local to server 414 or may be remote from server 414 and in communication with server 414 via a network-based or dedicated connection. Data repositories 416, 418 may be of different types. In certain aspects, a data repository used by server 414 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 416, 418 may also be used by applications to store application data. The data repositories used by applications may be of different types such as, for example, a key-value store repository, an object store repository, or a general storage repository supported by a file system.

In one embodiment, server 414 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

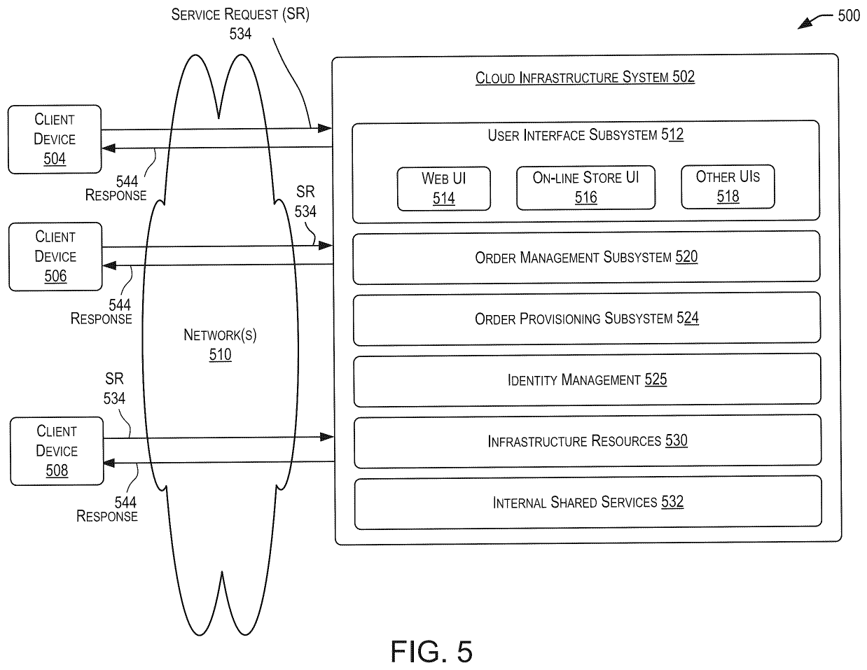

In certain aspects, the techniques for workload management. FIG. 5 is a simplified block diagram of a cloud-based system environment in which a workload management system may be implemented, in accordance with certain aspects. In the embodiment depicted in FIG. 5, cloud infrastructure system 502 may provide one or more cloud services that may be requested by users using one or more client computing devices 504, 506, and 508. Cloud infrastructure system 502 may comprise one or more computers and/or servers that may include those described above for server 414. The computers in cloud infrastructure system 502 may be organized as general purpose computers, specialized server computers, server farms, server clusters, or any other appropriate arrangement and/or combination.

Network(s) 510 may facilitate communication and exchange of data between clients 504, 506, and 508 and cloud infrastructure system 502. Network(s) 510 may include one or more networks. The networks may be of the same or different types. Network(s) 510 may support one or more communication protocols, including wired and/or wireless protocols, for facilitating the communications.

The embodiment depicted in FIG. 5 is only one example of a cloud infrastructure system and is not intended to be limiting. It should be appreciated that, in some other aspects, cloud infrastructure system 502 may have more or fewer components than those depicted in FIG. 5, may combine two or more components, or may have a different configuration or arrangement of components. For example, although FIG. 5 depicts three client computing devices, any number of client computing devices may be supported in alternative aspects.

The term cloud service is generally used to refer to a service that is made available to users on demand and via a communication network such as the Internet by systems (e.g., cloud infrastructure system 502) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 510 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 502 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 502 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 502. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 502. Cloud infrastructure system 502 then performs processing to provide the services requested in the tenant's subscription order. Cloud infrastructure system 502 may be configured to provide one or even multiple cloud services.

Cloud infrastructure system 502 may provide the cloud services via different deployment models. In a public cloud model, cloud infrastructure system 502 may be owned by a third party cloud services provider and the cloud services are offered to any general public tenant, where the tenant can be an individual or an enterprise. In certain other aspects, under a private cloud model, cloud infrastructure system 502 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 502 and the services provided may be shared by several organizations in a related community. Various other models such as hybrids of the above mentioned models may also be used.

Client computing devices 504, 506, and 508 may be of different types (such as devices 402, 404, 406, and 408 depicted in FIG. 4) and may be capable of operating one or more client applications. A user may use a client device to interact with cloud infrastructure system 502, such as to request a service provided by cloud infrastructure system 502.

In some aspects, the processing performed by cloud infrastructure system 502 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 502 for determining the intent of an utterance. The data used for this analysis may include structured data (e.g., data stored in a database or structured according to a structured model) and/or unstructured data (e.g., data blobs (binary large objects)).

As depicted in the embodiment in FIG. 5, cloud infrastructure system 502 may include infrastructure resources 530 that are utilized for facilitating the provision of various cloud services offered by cloud infrastructure system 502. Infrastructure resources 530 may include, for example, processing resources, storage or memory resources, networking resources, and the like.

In certain aspects, to facilitate efficient provisioning of these resources for supporting the various cloud services provided by cloud infrastructure system 502 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 502 may itself internally use services 532 that are shared by different components of cloud infrastructure system 502 and which facilitate the provisioning of services by cloud infrastructure system 502. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 502 may comprise multiple subsystems. These subsystems may be implemented in software, or hardware, or combinations thereof. As depicted in FIG. 5, the subsystems may include a user interface subsystem 512 that enables users of cloud infrastructure system 502 to interact with cloud infrastructure system 502. User interface subsystem 512 may include various different interfaces such as a web interface 514, an online store interface 516 where cloud services provided by cloud infrastructure system 502 are advertised and are purchasable by a consumer, and other interfaces 518. For example, a tenant may, using a client device, request (service request 534) one or more services provided by cloud infrastructure system 502 using one or more of interfaces 514, 516, and 518. For example, a tenant may access the online store, browse cloud services offered by cloud infrastructure system 502, and place a subscription order for one or more services offered by cloud infrastructure system 502 that the tenant wishes to subscribe to. The service request may include information identifying the tenant and one or more services that the tenant desires to subscribe to.

In certain aspects, such as the embodiment depicted in FIG. 5, cloud infrastructure system 502 may comprise an order management subsystem (OMS) 520 that is configured to process the new order. As part of this processing, OMS 520 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 520 may then invoke the order provisioning subsystem (OPS) 524 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 524 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 502 may send a response or notification 544 to the requesting tenant to indicate when the requested service is now ready for use. In some instances, information (e.g., a link) may be sent to the tenant that enables the tenant to start using and availing the benefits of the requested services.

Cloud infrastructure system 502 may provide services to multiple tenants. For each tenant, cloud infrastructure system 502 is responsible for managing information related to one or more subscription orders received from the tenant, maintaining tenant data related to the orders, and providing the requested services to the tenant or clients of the tenant. Cloud infrastructure system 502 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 502 may provide services to multiple tenants in parallel. Cloud infrastructure system 502 may store information for these tenants, including possibly proprietary information. In certain aspects, cloud infrastructure system 502 comprises an identity management subsystem (IMS) 528 that is configured to manage tenant's information and provide the separation of the managed information such that information related to one tenant is not accessible by another tenant. IMS 528 may be configured to provide various security-related services such as identity services, such as information access management, authentication and authorization services, services for managing tenant identities and roles and related capabilities, and the like.

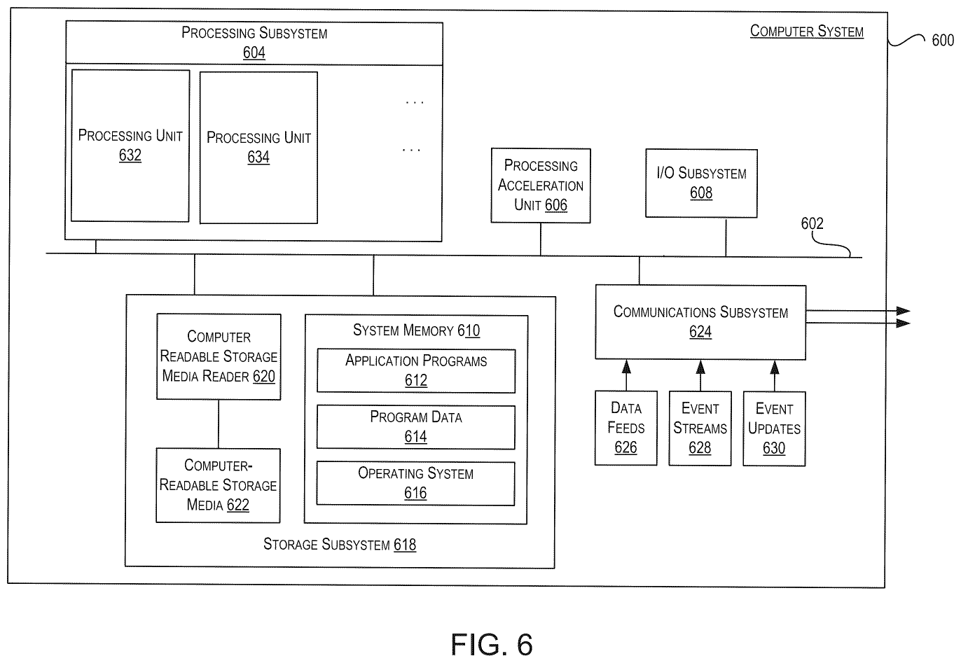

FIG. 6 illustrates an exemplary computer system 600 that may be used to implement certain aspects. As shown in FIG. 6, computer system 600 includes various subsystems including a processing subsystem 604 that communicates with a number of other subsystems via a bus subsystem 602. These other subsystems may include a processing acceleration unit 606, an I/O subsystem 608, a storage subsystem 618, and a communications subsystem 624. Storage subsystem 618 may include non-transitory computer-readable storage media including storage media 622 and a system memory 610.

Bus subsystem 602 provides a mechanism for letting the various components and subsystems of computer system 600 communicate with each other as intended. Although bus subsystem 602 is shown schematically as a single bus, alternative aspects of the bus subsystem may utilize multiple buses. Bus subsystem 602 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 604 controls the operation of computer system 600 and may comprise one or more processors, application specific integrated circuits (ASICs), or field programmable gate arrays (FPGAs). The processors may include a single core or multicore processors. The processing resources of computer system 600 can be organized into one or more processing units 632, 634, etc. A processing unit may include one or more processors, one or more cores from the same or different processors, a combination of cores and processors, or other combinations of cores and processors. In some aspects, processing subsystem 604 can include one or more special purpose co-processors such as graphics processors, digital signal processors (DSPs), or the like. In some aspects, some or all of the processing units of processing subsystem 604 can be implemented using customized circuits, such as application specific integrated circuits (ASICs), or field programmable gate arrays (FPGAs).

In some aspects, the processing units in processing subsystem 604 can execute instructions stored in system memory 610 or on computer readable storage media 622. In various aspects, the processing units can execute a variety of programs or code instructions and can maintain multiple concurrently executing programs or processes. At any given time, some or all of the program code to be executed can be resident in system memory 610 and/or on computer-readable storage media 622 including potentially on one or more storage devices. Through suitable programming, processing subsystem 604 can provide various functionalities described above. In instances where computer system 600 is executing one or more virtual machines, one or more processing units may be allocated to each virtual machine.

In certain aspects, a processing acceleration unit 606 may optionally be provided for performing customized processing or for off-loading some of the processing performed by processing subsystem 604 so as to accelerate the overall processing performed by computer system 600.

I/O subsystem 608 may include devices and mechanisms for inputting information to computer system 600 and/or for outputting information from or via computer system 600. In general, use of the term input device is intended to include all possible types of devices and mechanisms for inputting information to computer system 600. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 600 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 618 provides a repository or data store for storing information and data that is used by computer system 600. Storage subsystem 618 provides a tangible non-transitory computer-readable storage medium for storing the basic programming and data constructs that provide the functionality of some aspects. Storage subsystem 618 may store software (e.g., programs, code modules, instructions) that when executed by processing subsystem 604 provides the functionality described above. The software may be executed by one or more processing units of processing subsystem 604. Storage subsystem 618 may also provide a repository for storing data used in accordance with the teachings of this disclosure.

Storage subsystem 618 may include one or more non-transitory memory devices, including volatile and non-volatile memory devices. As shown in FIG. 6, storage subsystem 618 includes a system memory 610 and a computer-readable storage media 622. System memory 610 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 600, such as during start-up, may typically be stored in the ROM. The RAM typically contains data and/or program modules that are presently being operated and executed by processing subsystem 604. In some implementations, system memory 610 may include multiple different types of memory, such as static random access memory (SRAM), dynamic random access memory (DRAM), and the like.

By way of example, and not limitation, as depicted in FIG. 6, system memory 610 may load application programs 612 that are being executed, which may include various applications such as Web browsers, mid-tier applications, relational database management systems (RDBMS), etc., program data 614, and an operating system 616. By way of example, operating system 616 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 622 may store programming and data constructs that provide the functionality of some aspects. Computer-readable media 622 may provide storage of computer-readable instructions, data structures, program modules, and other data for computer system 600. Software (programs, code modules, instructions) that, when executed by processing subsystem 604 provides the functionality described above, may be stored in storage subsystem 618. By way of example, computer-readable storage media 622 may include non-volatile memory such as a hard disk drive, a magnetic disk drive, an optical disk drive such as a CD ROM, digital video disc (DVD), a Blu-Ray® disk, or other optical media. Computer-readable storage media 622 may include, but is not limited to, Zip® drives, flash memory cards, universal serial bus (USB) flash drives, secure digital (SD) cards, DVD disks, digital video tape, and the like. Computer-readable storage media 622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 618 may also include a computer-readable storage media reader 620 that can further be connected to computer-readable storage media 622. Reader 620 may receive and be configured to read data from a memory device such as a disk, a flash drive, etc.

In certain aspects, computer system 600 may support virtualization technologies, including but not limited to virtualization of processing and memory resources. For example, computer system 600 may provide support for executing one or more virtual machines. In certain aspects, computer system 600 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 600. Accordingly, multiple operating systems may potentially be run concurrently by computer system 600.

Communications subsystem 624 provides an interface to other computer systems and networks. Communications subsystem 624 serves as an interface for receiving data from and transmitting data to other systems from computer system 600. For example, communications subsystem 624 may enable computer system 600 to establish a communication channel to one or more client devices via the Internet for receiving and sending information from and to the client devices.

Communication subsystem 624 may support both wired and/or wireless communication protocols. For example, in certain aspects, communications subsystem 624 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 624 can provide wired network connectivity (e.g., Ethernet) in addition to or instead of a wireless interface.

Communication subsystem 624 can receive and transmit data in various forms. For example, in some aspects, in addition to other forms, communications subsystem 624 may receive input communications in the form of structured and/or unstructured data feeds 626, event streams 628, event updates 630, and the like. For example, communications subsystem 624 may be configured to receive (or send) data feeds 626 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 624 may be configured to receive data in the form of continuous data streams, which may include event streams 628 of real-time events and/or event updates 630, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 624 may also be configured to communicate data from computer system 600 to other computer systems or networks. The data may be communicated in various different forms such as structured and/or unstructured data feeds 626, event streams 628, event updates 630, and the like to one or more databases that may be in communication with one or more streaming data source computers coupled to computer system 600.

Computer system 600 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 600 depicted in FIG. 6 is intended only as a specific example. Many other configurations having more or fewer components than the system depicted in FIG. 6 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
monitoring a tenant-specific workload for a tenant on a first set of one or more cloud service instances hosted by a first cloud services infrastructure at a first cloud service location;
based at least in part on tenant-specific metadata, determining that a second cloud service location, in which a second cloud services infrastructure hosts one or more other cloud service instances, can host a predicted tenant-specific workload based on the tenant-specific workload;
obtaining weather data for the first cloud service location and the second cloud service location;
based at least in part on the predicted tenant-specific workload and the weather data for the first cloud service location, determining a first non-carbon cost of hosting the predicted tenant-specific workload while maintaining baseline performance criteria for the tenant by the first cloud services infrastructure at the first cloud service location for a future period of time and a first carbon cost to host the predicted tenant-specific workload for the tenant by the first cloud services infrastructure at the first cloud service location for the future period of time;
based at least in part on the predicted tenant-specific workload and the weather data for the second cloud service location, determining a second non-carbon cost of newly hosting the predicted tenant-specific workload while maintaining the baseline performance criteria for the tenant by the second cloud services infrastructure at the second cloud service location for the future period of time and a second carbon cost to newly host the predicted tenant-specific workload for the tenant by the second cloud services infrastructure at the second cloud service location for the future period of time;
based at least in part on the first non-carbon cost, the second non-carbon cost, the first carbon cost, and the second carbon cost, storing an indication that one or more conditions are satisfied, wherein the one or more conditions comprise that carbon emissions will be reduced within one or more performance constraints by newly hosting the predicted tenant-specific workload by the second cloud services infrastructure; and
routing an ongoing tenant-specific workload corresponding to the predicted tenant-specific workload to a second set of one or more cloud service instances hosted by the second cloud services infrastructure at the second cloud service location.

2. The computer-implemented method of claim 1, further comprising:
in response to the indication that the one or more conditions are satisfied, checking a workload transition setting to verify whether the ongoing tenant-specific workload should be transitioned automatically when the one or more conditions are satisfied; and
based at least in part on determining that the ongoing tenant-specific workload should be transitioned automatically, automatically configuring, without a precondition on receiving user approval, the second set of one or more cloud service instances to store one or more database structures, including one or more particular database structures in memory, for hosting the ongoing tenant-specific workload;
wherein the routing the ongoing tenant-specific workload to the second set of one or more cloud service instances is performed automatically in response to a confirmation that the second set of one or more cloud service instances has been configured to store the one or more database structures, including the one or more particular database structures in a memory, for hosting the ongoing tenant-specific workload.

3. The computer-implemented method of claim 1, wherein the baseline performance criteria is determined based at least in part on an agreement to host the tenant-specific workload,
wherein the first non-carbon cost comprises a first resource operation cost,
wherein the second non-carbon cost comprises a second resource operation cost,
wherein the method further comprises:
obtaining first resource operation information of the first cloud service location;
obtaining second resource operation information of the second cloud service location;
determining the first resource operation cost based at least in part on the first resource operation information; and
determining the second resource operation cost based at least in part on the second resource operation information,
wherein the determining the first carbon cost is based at least in part on a first carbon cost of electricity of the first resource operation information, and
wherein the determining the second carbon cost is based at least in part on a second carbon cost of electricity of the second resource operation information.

4. The computer-implemented method of claim 1, wherein the determining the first carbon cost comprises:
determining a first carbon cost of electricity for a first energy source; and
determining a second carbon cost of electricity for a second energy source; and
wherein method further comprises:
determining the lower carbon cost of electricity of the first carbon cost of electricity and the second carbon cost of electricity; and
storing, within the indication that carbon emissions will be reduced, the lower carbon cost of electricity.

5. The computer-implemented method of claim 1, wherein the future period of time is a first future season of the year, and wherein the method further comprises:
based at least in part on the predicted tenant-specific workload and the weather data for the first cloud service location, determining a third carbon cost to continue hosting a second predicted tenant-specific workload for the tenant by the first cloud services infrastructure at the first cloud service location for a second future season of the year, wherein the second predicted tenant-specific workload is different from the predicted tenant-specific workload;
based at least in part on the predicted tenant-specific workload and the weather data for the second cloud service location, determining a fourth carbon cost to newly host the second predicted tenant-specific workload for the tenant by the second cloud services infrastructure at the second cloud service location for the second future season of the year; and
based at least in part on the third carbon cost and the fourth carbon cost, storing a second indication that one or more conditions are not satisfied for the second future season of the year, wherein the one or more conditions for the second future season of the year comprise that carbon emissions are predicted to be reduced within one or more performance constraints by newly hosting the second predicted tenant-specific workload by the second cloud services infrastructure for the second future season of the year.

6. The computer-implemented method of claim 1, wherein the determining the first carbon cost further comprises:
determining a third carbon cost based on a first source of energy for the first cloud service location;
determining a fourth carbon cost based on a second source of energy for the first cloud service location; and
storing the lower of the third carbon cost and the fourth carbon cost as the first carbon cost;
wherein the determining the second carbon cost further comprises:
determining a fifth carbon cost based on a third source of energy for the second cloud service location;
determining a sixth carbon cost based on a fourth source of energy for the second cloud service location; and
storing the lower of the fifth carbon cost and the sixth carbon cost as the second carbon cost.

7. The computer-implemented method of claim 1, wherein the one or more performance constraints comprises a first expected request latency between client requests and the second cloud service location; and wherein determining the second non-carbon cost further comprises:
modeling client location clusters;
modeling client requests for each location cluster;
assigning a weight of requests per location based on a workload volume of each location;
determining an aggregate latency for each location cluster, between the location cluster and the second cloud service location;
weighting the aggregate latencies based on the weight of requests per location;
determining a second expected request latency based on the weighted aggregate latencies;
comparing the second expected request latency and the first expected request latency; and
storing a difference between the second expected request latency and the first expected request latency in the non-carbon cost.

8. The computer-implemented method of claim 1, wherein the determining that the second cloud service location can host the predicted tenant-specific workload further comprises:
checking a table of cloud service locations for the second cloud service location, wherein the table of cloud service locations comprises data of at least one of:
locations identified by the tenant to be valid locations;
locations identified by the tenant to not be valid locations;
location filters based on regulations; and
data of server features at each location.

9. The computer-implemented method of claim 1, wherein, before routing the ongoing tenant-specific workload, the method further comprises:
checking for a second indication that one or more second conditions are satisfied, wherein the one or more second conditions comprise that carbon emissions will be reduced for a second predicted workload of a second tenant by hosting the second predicted workload by the second cloud services infrastructure at the second cloud services infrastructure; and
comparing the second carbon cost and a third carbon cost to host the second predicted workload by the second cloud services infrastructure at the second cloud service location,
wherein the routing the ongoing tenant-specific workload is based at least in part on the second carbon cost being lower than the third carbon cost.

10. The computer-implemented method of claim 9, wherein, before routing the ongoing tenant-specific workload, a second workload of the second tenant is hosted by the second cloud services infrastructure at the second cloud service location, the method further comprising re-routing a second ongoing tenant-specific workload of the second tenant corresponding to the second predicted workload to another cloud services infrastructure other than the second cloud services infrastructure at the second cloud service location to increase an available capacity of the second cloud services infrastructure to handle the ongoing tenant-specific workload for the tenant.

11. The computer-implemented method of claim 10, wherein the re-routing of the second ongoing tenant-specific workload is performed after checking a policy of the second tenant to confirm that the second tenant indicated, in the policy, a preference to move workload of the second tenant if workload of another tenant would result in greater carbon efficiency.

12. The computer-implemented method of claim 1, wherein the routing the ongoing tenant-specific workload comprises updating an intermediate server between client devices and the second cloud service location to address requests to at least one cloud service instance of the second set of one or more cloud service instances, wherein the updating includes sending an address of the at least one cloud service instance of the second set of one or more cloud service instances to the intermediate server.

13. The computer-implemented method of claim 1, wherein the tenant specific workload comprises at least one of:
a front-end process,
a back-end process, or
data processing for a data set.

14. A computer-program product comprising one or more non-transitory machine-readable storage media, including stored instructions configured to cause a computing system to perform a set of actions including:
monitoring a tenant-specific workload for a tenant on a first set of one or more cloud service instances hosted by a first cloud services infrastructure at a first cloud service location;
based at least in part on tenant-specific metadata, determining that a second cloud service location, in which a second cloud services infrastructure hosts one or more other cloud service instances, can host a predicted tenant-specific workload based on the tenant-specific workload;
obtaining weather data for the first cloud service location and a second cloud service location;
based at least in part on the predicted tenant-specific workload and the weather data for the first cloud service location, determining a first non-carbon cost of hosting the predicted tenant-specific workload while maintaining baseline performance criteria for the tenant by the first cloud services infrastructure at the first cloud service location for a future period of time and a first carbon cost to host the predicted tenant-specific workload for the tenant by the first cloud services infrastructure at the first cloud service location for the future period of time;
based at least in part on the predicted tenant-specific workload and the weather data for the second cloud service location, determining a second non-carbon cost of newly hosting the predicted tenant-specific workload while maintaining baseline performance criteria for the tenant by the second cloud services infrastructure at the second cloud service location for the future period of time and a second carbon cost to newly host the predicted tenant-specific workload for the tenant by the second cloud services infrastructure at the second cloud service location for the future period of time;
based at least in part on the first non-carbon cost, the second non-carbon cost, the first carbon cost, and the second carbon cost, storing an indication that one or more conditions are satisfied, wherein the one or more conditions comprise that carbon emissions will be reduced within one or more performance constraints by newly hosting the predicted tenant-specific workload by the second cloud services infrastructure; and
routing an ongoing tenant-specific workload corresponding to the predicted tenant-specific workload to a second set of one or more cloud service instances hosted by the second cloud services infrastructure at the second cloud service location.

15. The computer-program product of claim 14, wherein the set of actions further includes:
in response to the indication that the one or more conditions are satisfied, checking a workload transition setting to verify whether the ongoing tenant-specific workload should be transitioned automatically when the one or more conditions are satisfied; and
based at least in part on determining that the ongoing tenant-specific workload should be transitioned automatically, automatically configuring, without a precondition on receiving user approval, the second set of one or more cloud service instances to store one or more database structures, including one or more particular database structures in memory, for hosting the ongoing tenant-specific workload;
wherein the routing the ongoing tenant-specific workload to a second set of one or more cloud service instances is performed automatically in response to a confirmation that the second set of one or more cloud service instances has been configured to store the one or more database structures, including the one or more particular database structures in memory, for hosting the ongoing tenant-specific workload.

16. The computer-program product of claim 14, wherein the baseline performance criteria is determined based at least in part on an agreement to host the tenant-specific workload,
wherein the first non-carbon cost comprises a first resource operation cost,
wherein the second non-carbon cost comprises a second resource operation cost, and
wherein the set of actions further includes:
obtaining first resource operation information of the first cloud service location;
obtaining second resource operation information of the second cloud service location;
determining the first resource operation cost based at least in part on the first resource operation information; and
determining the second resource operation cost based at least in part on the second resource operation information,
wherein the determining the first carbon cost is based at least in part on a first carbon cost of electricity of the first resource operation information, and
wherein the determining the second carbon cost is based at least in part on a second carbon cost of electricity of the second resource operation information.

17. The computer-program product of claim 14, wherein the future period of time is a first future season of the year, and wherein the set of actions further includes:
based at least in part on the predicted tenant-specific workload and the weather data for the first cloud service location, determining a third carbon cost to continue hosting an predicted tenant-specific workload for the tenant by the first cloud services infrastructure at the first cloud service location for a second future season of the year, wherein the second predicted tenant-specific workload is different from the predicted tenant-specific workload;
based at least in part on the predicted tenant-specific workload and the weather data for the second cloud service location, determining a fourth carbon cost to newly host the second predicted tenant-specific workload for the tenant by the second cloud services infrastructure at the second cloud service location for the second future season of the year; and
based at least in part on the third carbon cost and the fourth carbon cost, storing an indication that one or more conditions are not satisfied for the second future season of the year, wherein the one or more conditions for the second future season of the year comprise that carbon emissions are predicted to be reduced within one or more performance constraints by newly hosting the second predicted tenant-specific workload by the second cloud services infrastructure for the second future season of the year.

18. The computer-program product of claim 14, wherein, before routing the ongoing tenant-specific workload, the set of actions further includes:
checking for a second indication that one or more second conditions are satisfied, wherein the one or more second conditions comprise that carbon emissions will be reduced for a second predicted workload of a second tenant by hosting the second predicted workload by the second cloud services infrastructure at the second cloud services infrastructure; and
comparing the second carbon cost and a third carbon cost to host the second predicted workload by the second cloud services infrastructure at the second cloud service location,
wherein the routing the ongoing tenant-specific workload is based at least in part on the second carbon cost being lower than the third carbon cost.

19. A system comprising:
one or more processors; and
one or more non-transitory computer-readable media storing instructions, which, when executed by the system, cause the system to perform a set of actions including:
monitoring a tenant-specific workload for a tenant on a first set of one or more cloud service instances hosted by a first cloud services infrastructure at a first cloud service location;
based at least in part on tenant-specific metadata, determining that a second cloud service location, in which a second cloud services infrastructure hosts one or more other cloud service instances, can host a predicted tenant-specific workload based on the tenant-specific workload;
obtaining weather data for the first cloud service location and a second cloud service location;
based at least in part on the predicted tenant-specific workload and the weather data for the first cloud service location, determining a first non-carbon cost of hosting the predicted tenant-specific workload while maintaining baseline performance criteria for the tenant by the first cloud services infrastructure at the first cloud service location for a future period of time and a first carbon cost to host the predicted tenant-specific workload for the tenant by the first cloud services infrastructure at the first cloud service location for the future period of time;
based at least in part on the predicted tenant-specific workload and the weather data for the second cloud service location, determining a second non-carbon cost of newly hosting the predicted tenant-specific workload while maintaining baseline performance criteria for the tenant by the second cloud services infrastructure at the second cloud service location for the future period of time and a second carbon cost to newly host the predicted tenant-specific workload for the tenant by the second cloud services infrastructure at the second cloud service location for the future period of time;
based at least in part on the first non-carbon cost, the second non-carbon cost, the first carbon cost, and the second carbon cost, storing an indication that one or more conditions are satisfied, wherein the one or more conditions comprise that carbon emissions will be reduced within one or more performance constraints by newly hosting the predicted tenant-specific workload by the second cloud services infrastructure; and
routing an ongoing tenant-specific workload corresponding to the predicted tenant-specific workload to a second set of one or more cloud service instances hosted by the second cloud services infrastructure at the second cloud service location.

20. The system of claim 19, wherein the set of actions further includes:
in response to the indication that the one or more conditions are satisfied, checking a workload transition setting to verify whether the ongoing tenant-specific workload should be transitioned automatically when the one or more conditions are satisfied; and
based at least in part on determining that the ongoing tenant-specific workload should be transitioned automatically, automatically configuring, without a precondition on receiving user approval, the second set of one or more cloud service instances to store one or more database structures, including one or more particular database structures in memory, for hosting the ongoing tenant-specific workload;
wherein the routing the ongoing tenant-specific workload to a second set of one or more cloud service instances is performed automatically in response to a confirmation that the second set of one or more cloud service instances has been configured to store the one or more database structures, including the one or more particular database structures in memory, for hosting the ongoing tenant-specific workload.

21. The system of claim 19, wherein the baseline performance criteria is determined based at least in part on an agreement to host the tenant-specific workload,
wherein the first non-carbon cost comprises a first resource operation cost,
wherein the second non-carbon cost comprises a second resource operation cost, and
wherein the set of actions further includes:
obtaining first resource operation information of the first cloud service location;
obtaining second resource operation information of the second cloud service location;
determining the first resource operation cost based at least in part on the first resource operation information; and
determining the second resource operation cost based at least in part on the second resource operation information,
wherein the determining the first carbon cost is based at least in part on a first carbon cost of electricity of the first resource operation information, and
wherein the determining the second carbon cost is based at least in part on a second carbon cost of electricity of the second resource operation information.

22. The system of claim 19, wherein the future period of time is a first future season of the year, and wherein the set of actions further includes:
based at least in part on the predicted tenant-specific workload and the weather data for the first cloud service location, determining a third carbon cost to continue hosting a second predicted tenant-specific workload for the tenant by the first cloud services infrastructure at the first cloud service location for a second future season of the year, wherein the second predicted tenant-specific workload is different from the predicted tenant-specific workload;
based at least in part on the predicted tenant-specific workload and the weather data for the second cloud service location, determining a fourth carbon cost to newly host the second predicted tenant-specific workload for the tenant by the second cloud services infrastructure at the second cloud service location for the second future season of the year; and
based at least in part on the third carbon cost and the fourth carbon cost, storing an indication that one or more conditions are not satisfied for the second future season of the year, wherein the one or more conditions for the second future season of the year comprise that carbon emissions are predicted to be reduced within one or more performance constraints by newly hosting the second predicted tenant-specific workload by the second cloud services infrastructure for the second future season of the year.

23. The system of claim 19, wherein, before routing the ongoing tenant-specific workload, the set of actions further includes:
checking for a second indication that one or more second conditions are satisfied, wherein the one or more second conditions comprise that carbon emissions will be reduced for a second predicted workload of a second tenant by hosting the second predicted workload by the second cloud services infrastructure at the second cloud services infrastructure; and
comparing the second carbon cost and a third carbon cost to host the second predicted workload by the second cloud services infrastructure at the second cloud service location,
wherein the routing the ongoing tenant-specific workload is based at least in part on the second carbon cost being lower than the third carbon cost.
